(19) United States
(12) Patent Application Publication
(10) Pub. No.: US 2002/0094208 A1
(43) Pub. Date: Jul. 18, 2002

(54) Multi-color printer with keyed print cartridges

(76) Inventor: Franklin Joseph Palumbo, Nicholasvill, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/765,032

(22) Filed: Jan. 18, 2001

(51) Int. Cl. G03G 15/00

(52) U.S. Cl. 399/12

(57) ABSTRACT

A multi-color printer includes a plurality of print cartridges and a frame. Each print cartridge corresponds to a different color to be printed, and includes a keying feature different from the other print cartridges. The frame defines a plurality of docking stations, with each docking station including a mating keying feature only allowing interconnection with a correspondingly keyed print cartridge. Each keying feature is in the form of at least one tab and each mating keying feature is in the form of at least one corresponding recess. Each recess is positioned to receive a corresponding tab of a corresponding print cartridge. Each mating keying feature defines a hard stop with the keying features of the print cartridges other than the correspondingly keyed print cartridge.

### BACKGROUND OF THE INVENTION

1. Field of the Invention

The present invention relates to electrophotographic printers, and, more particularly, to multi-color electrophotographic printers having multiple print cartridges.

2. Description of the Related Art

An electrophotographic (EP) printer, commonly referred to as a laser printer, deposits toner particles onto a print medium using an electrophotographic process. In the case of a multi-color EP printer, mutiple toner cartridges are carried by the frame on the printer, with each toner cartridge corresponding to a different color toner which is to be deposited at selected pixel locations on the print medium. In the case of a four cartridge printer, the print cartridges respectively carry black, cyan, yellow and magenta toner particles therein for depositing on the print medium at selected pixel locations.

The deposition of the different color toner particles using the different print cartridges is typically carried out in software within the printer. It is assumed that each different color print cartridge is correctly installed at a corresponding docking station within the multi-color printer. However, if the different color print cartridges are configured the same, it is possible for a print cartridge to be incorrectly installed at a different docking station within the printer. This of course is not desirable. What is needed in the art is a multi-color printer having multiple print cartridges that are keyed so as to avoid improper installation within the printer.

### SUMMARY OF THE INVENTION

The present invention provides a multi-color printer with multiple print cartridges which are keyed to a corresponding docking station using both mechanical as well as visual keys.

The invention comprises, in one form thereof, a multi-color printer including a plurality of print cartridges and a frame. Each print cartridge corresponds to a different color to be printed, and includes a keying feature different from the other print cartridges. The frame defines a plurality of docking stations. Each docking station includes a mating keying feature only allowing interconnection with a correspondingly keyed print cartridge. Each keying feature and corresponding mating keying feature have a unique visual indicator in the form of matching colors which are different from one docking station to another.

The invention comprises, in another form thereof, a multi-color printer including a plurality of print cartridges and a frame. Each print cartridge corresponds to a different color to be printed, and includes a keying feature different from the other print cartridges. The frame defines a plurality of docking stations, with each docking station including a mating keying feature only allowing interconnection with a correspondingly keyed print cartridge. Each keying feature is in the form of at least one tab and each mating keying feature is in the form of at least one corresponding recess. Each recess is positioned to receive a corresponding tab of a corresponding print cartridge. Each mating keying feature defines a hard stop with the keying features of the print cartridges other than the correspondingly keyed print cartridge.

An advantage of the present invention is that dual keying in the form of mechanical as well as visual keying is provided.

Another advantage is the mechanical keying of each print cartridge defines a hard stop if the print cartridge is attempted to be installed at an incorrect docking station.

Yet another advantage is the keying features and mating keying features may be configured with geometric and/or positional constraints so that only a particular print cartridge may be received at a corresponding docking station.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a portion of an embodiment of a multi-color printer of the present invention; and

FIG. 2 is an enlarged, perspective view illustrating engagement between the print cartridge and frame shown in FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

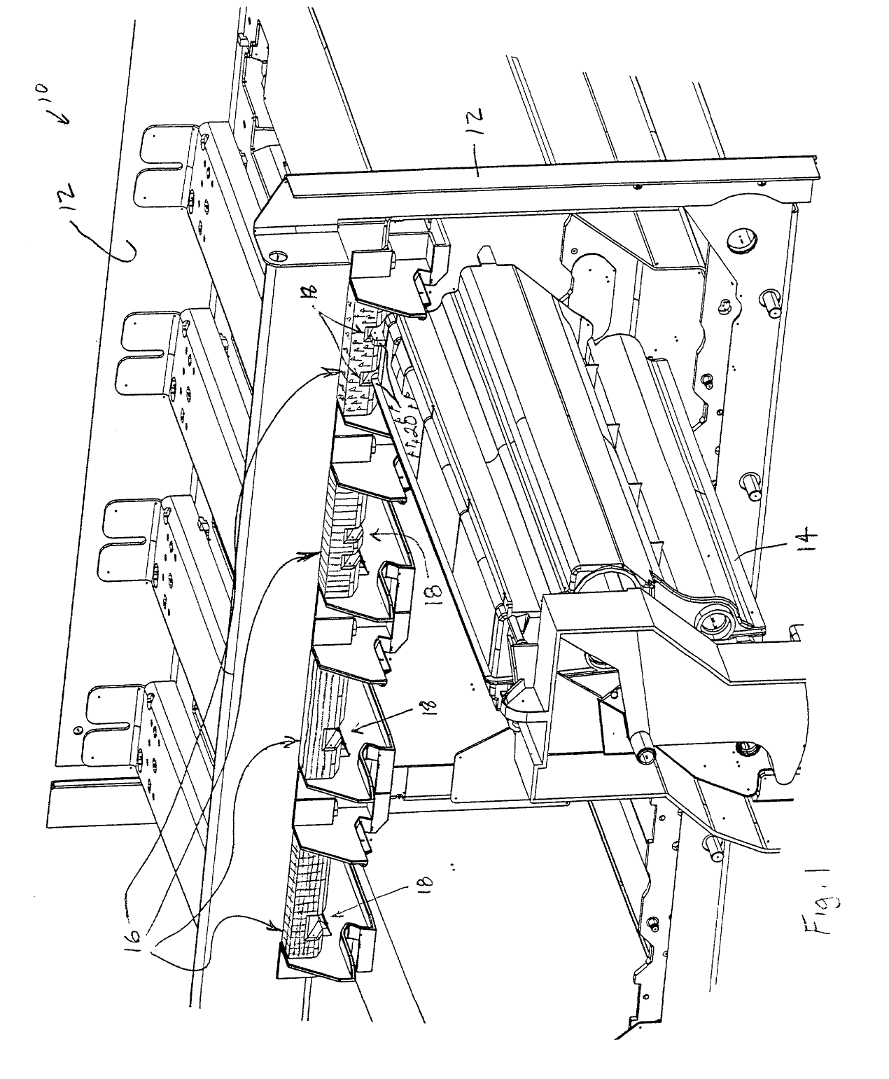

Referring now to the drawings, and more particularly to FIG. 1, there is shown a portion of an embodiment of a multi-color printer 10 of the present invention. In the embodiment shown, multi-color printer 10 is in the form of an electrophotographic printer which includes a frame 12 and a plurality of print cartridges 14 (one of which is shown for simplicity sake).

Frame 12 is configured to define a plurality of docking stations 16, with each docking station 16 corresponding to a different print cartridge 14 which is carried by frame 12 and used to print a different color on a print medium (not shown). Each docking station 16 includes a mating keying feature 18 which only allows interconnection with a corresponding keyed print cartridge 14, as will be described in more detail hereinafter. More particularly, each mating keying feature 18 at each docking station 16 is in the form of at least one recess which is configured with a geometric and/or positional constraint relative to a keying feature of a correspondingly keyed print cartridge 14. In addition, each mating keying feature 18 has a unique visual indicator in the form of a particular color which is different from one docking station 16 to another. In the embodiment shown, each mating keying feature is color coded with a color corresponding to the particular color toner carried within a corresponding print cartridge 14. Mating keying features 18 are shown from left to right in FIG. 1 with cross hatching corresponding to the different color codes, i.e., black, cyan, magenta and yellow. These are the primary color print cartridges typically carried by an electrophotographic printer for the purpose of producing a multi-color image on a print medium. The black and cyan mating keying features 18 are shown with a single female recess which are sized and positioned different from each other so that only the corresponding print cartridges 14 may be received at the particular docking station 16. The magenta and yellow mating keying features are shown with a pair of female recess which are spaced apart form each other at different distances relative to each other so that only a single print cartridge 14 may be properly engaged at a corresponding docking station 16.

Each print cartridge 14 corresponds to a different color to be printed on the print medium. As indicated above, printer 10 is an electrophotographic printer in the embodiment shown. Thus, each print cartridge 14 is in the form of a toner cartridge carrying toner particles therein which are deposited at selected pixel locations on a print medium to form a multi-color image. The general configuration of each print cartridge 14 is the same from one print cartridge to another, except for the keying features to be described in more detail hereinafter. Thus, only a single print cartridge 14 corresponding to a yellow print cartridge is shown in FIG. 1 for simplicity sake. From the discussion of yellow print cartridge 14 which follows hereinafter, it will be readily apparent how the keying features of the remaining print cartridges 14 are configured.

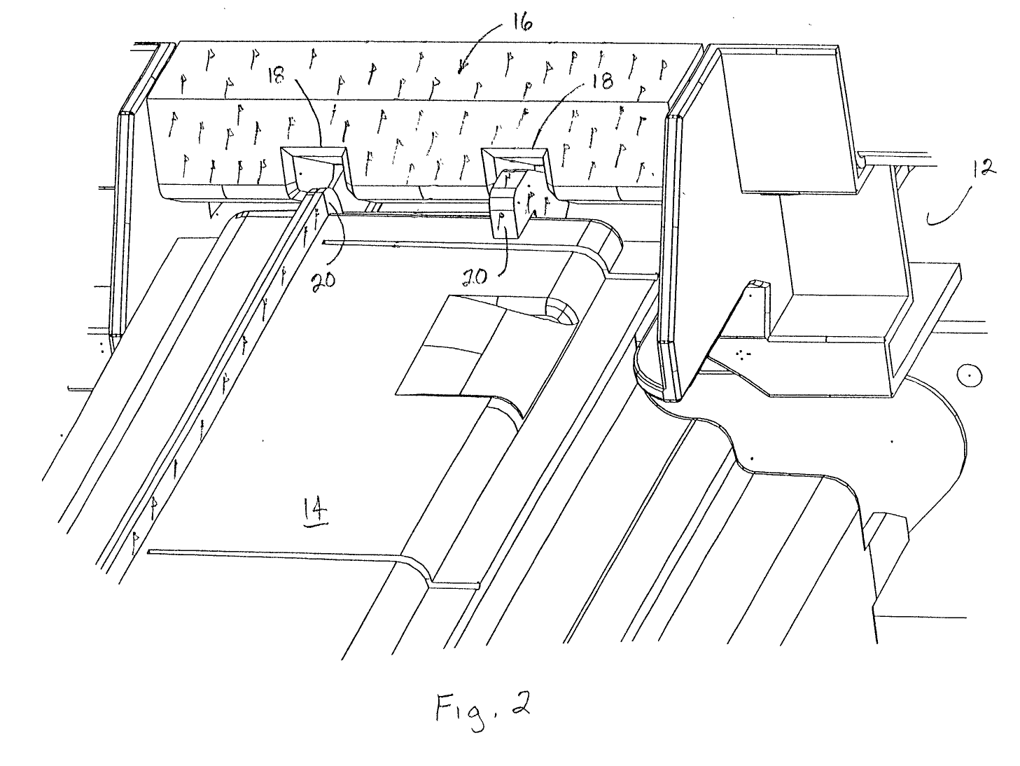

Print cartridge 14 includes a keying feature 20 which is different from a keying feature of the remaining print cartridges 14, and mates with the mating keying feature 18 at yellow docking station 16. More particularly, keying feature 20 of yellow print cartridge 14 is in the form of a pair of male tabs 20 (FIG. 2) which fit into corresponding female recesses defining the mating keying feature 18 at yellow docking station 16. The leftmost male tab 20 and the rightmost male tab 20 are each fixed to allow yellow print cartridge 14 to be engaged at yellow docking station 16.

Keying feature 20 of yellow print cartridge 14 is color coded with a yellow color to match the yellow color of mating keying feature 18 at yellow docking station 16. In this manner, the user can quickly and easily ascertain at which docking station 16 yellow print cartridge 14 is to be installed. In the embodiment shown, only keying feature 20 in the form of the two male tabs are color coded yellow. However, it is also possible to color code the entire top or only a portion of print cartridge 14 to provide the color coding between keying feature 20 and mating keying feature 18. In this manner, redundant keying is provided between print cartridge 14 and docking station 16. To wit, keying feature 20 and mating keying feature 18 define a mechanical key, while the color coding between keying feature 20 and mating keying feature 18 define a visual key.

In the embodiment of multi-color printer 10 of the present invention shown and described above, each keying feature 20 and mating keying feature 18 is color coded to allow a user to quickly and easily determine at which docking station a particular print cartridge is to be installed. The color coding is provided by utilizing a plastic having the particular desired color. However, it is also to be appreciated that the color coding may be provided by other techniques. For example, stickers or labels of a particular color may be placed on a print cartridge or docking station to provide the desired color coding for ease of instillation.

Furthermore, in the embodiment of printer 10 shown and described above, keying feature 20 and mating keying feature 18 are configured as mating projections and recesses which interconnect with each other during installation. However, it is to also be understood that the keying features and mating keying features may be differently configured. For example, the frame of the printer may be provided with projections or tabs at each docking station location which are positioned corresponding to the particular color cartridge to be received thereat. Each cartridge for each given color toner may in turn include a plurality of projections corresponding to the different possible tab locations at each docking station. During manufacture, a selected tab on the toner cartridge may be removed to thereby define a recess for receiving the corresponding tab on the frame therein.

During installation, yellow print cartridge 14 is aligned at yellow docking station 16 and slid in a downward direction. Keying feature 20 in the form of the two male tabs align with the mating keying feature 18 in the form of the two female recesses. Keying features 20 thus fit within mating keying feature 18 at yellow docking station 16. Keying feature 20 of yellow print cartridge 14 is color coded yellow so that a user may quickly and easily see at which docking station 16 yellow print cartridge 14 is to be installed. In the event that the different print cartridge with a different keying feature corresponding to a different color toner is attempted to be installed at yellow docking station 16, the keying feature thereof defines a hard stop such that the print cartridge 14 cannot be installed at an improper docking station.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A multi-color printer, comprising:
a plurality of print cartridges, each corresponding to a different color to be printed, each said print cartridge including a keying feature different from other said print cartridges; and
a frame defining a plurality of docking stations, each said docking station including a mating keying feature only allowing interconnection with a correspondingly keyed print cartridge.

2. The multi-color printer of claim 1, each said keying feature being in the form of at least one tab and each said mating keying feature being in the form of at least one corresponding recess, each said recess positioned to receive a corresponding said tab of a corresponding said print cartridge.

3. The multi-color printer of claim 2, said keying features including at least one of geometric and positional constraints relative to said keying features of said correspondingly keyed print cartridge.

4. The multi-color printer of claim 2, each said mating keying feature defining a hard stop with said keying feature of said print cartridges other than said correspondingly keyed print cartridge.

5. The multi-color printer of claim 1, wherein said printer comprises an electrophotographic printer.

6. The multi-color printer of claim 1, each said keying feature and said corresponding mating keying feature having a unique visual indicator in the form of matching colors which are different from one docking station to another.

7. A multi-color printer, comprising:
a plurality of print cartridges, each corresponding to a different color to be printed, each said print cartridge including a keying feature different from other said print cartridges; and
a frame defining a plurality of docking stations, each said docking station including a mating keying feature only allowing interconnection with a correspondingly keyed print cartridge, each said keying feature being in the form of at least one tab and each said mating keying feature being in the form of at least one corresponding recess, each said recess positioned to receive a corresponding said tab of a corresponding said print cartridge, each said mating keying feature defining a hard stop with said keying feature of said print cartridges other than said correspondingly keyed print cartridge.

8. The multi-color printer of claim 7, said keying features including at least one of geometric and positional constraints relative to said mating keying features of said correspondingly keyed print cartridge.

9. The multi-color printer of claim 8, wherein said printer comprises an electrophotographic printer.
